SEQUENCE LISTING (1 sequence)

SEQ ID NO: 1 - protein, 242 aa, Artificial Sequence
  Description of Artificial Sequence Synthetic silk-like protein
TSGGAGSGYGGGYGHGYGSDGGGAGAGSGAGAGSGAGAGSASGGAGSGYGGGYGHGYGSDGGGAGAGSGAGAGSGAGAGSASGGAGSGYGGGYGHGYGSDGGGAGAGSGAGAGSGAGAGSASGGAGSGYGGGYGHGYGSDGGGAGAGSGAGAGSGAGAGSASGGAGSGYGGGYGHGYGSDGGGAGAGSGAGAGSGAGAGSASGGAGSGYGGGYGHGYGSDGGGAGAGSGAGAGSGAGAGSAS

(19) United States
(12) Patent Application Publication
(10) Pub. No.: US 2004/0185737 A1
(43) Pub. Date: Sep. 23, 2004

(54) Non-woven fabric comprising ultra-fine fiber of silk fibroin and/or silk-like material, and method for production thereof

(76) Inventor: Tetsuo Asakura, Tokyo (JP)

Correspondence Address: Millen White, Zelano & Branigan, Arlington Courthouse Plaza I, 2200 Clarendon Boulevard Suite 1400, Arlington, VA, 22201, US

(21) Appl. No.: 10/471,587

(22) PCT Filed: Mar. 14, 2002
(86) PCT No.: PCT/JP02/02419

(30) Foreign Application Priority Data
Mar. 14, 2003 (WO) PCT/JP02/02026

(51) Int. Cl. B29D 28/00; D01D 5/00; D04H 3/02

(52) U.S. Cl. 442/340; 264/464; 264/103

(57) ABSTRACT

A nonwoven fabric comprising silk fibroin and/or very fine fibers of a silk-material, and a method of preparing a nonwoven fabric comprising silk or a silk-like material wherein said silk fibroin and/or silk-like material is dissolved in hexafluoroacetone hydrate or a solvent having this as its main component, and then performing electrospinning.

### FIELD OF THE INVENTION

This invention relates to a nonwoven fabric comprising silk and/or a silk-like material, and in particular to a nonwoven fabric comprising very fine fibers of silk and/or silk-like material manufactured using hexafluoroacetone hydrate as solvent, and to a method of manufacturing same.

### BACKGROUND OF THE INVENTION

In recent years, with the progress of biotechnology, many attempts have been made to produce-silk like substances comprising various types of fibers using E.coli, yeast or animals such as goats. Therefore, it is necessary to discover solvents having excellent properties for producing fibers and films from a silk-like substance. It is also necessary to find an excellent solvent for producing single filament fibers with desired size from B.mori silk fibroin and wild silkworm fibroin which do not occur naturally. Conventionally, hexafluoroisopropanol (HFIP) is frequently used as a solvent for obtaining regenerated B.mori silk fibers which are not liable to decrease of molecular weight and have outstanding mechanical properties (U.S. Pat. No. 5,252,285).

However, as natural B.mori silk fibers can not dissolve in HFIP, the fibers are firstly dissolved in an aqueous solution of a salt such as lithium bromide, removing the salt by dialysis, drying for the film formation, and then dissolving the obtained silk fibroin film in HFIP.

However, as long as eight days were required to dissolve the silk film in HFIP (U.S. Pat. No. 5,252,285).

Moreover, the wild silkworm silk fibroin fibers, such as S.c.ricini, can not dissolve in HFIP.

The Inventor carried out researches on the interaction of silk fibroins with various solvents using NMR spectroscopy to find the solvent which is superior to HFIP, and discovered that hexafluoroacetone hydrate (hereafter referred to as HFA) was excellent for producing fibers and films from silk-like substances. The inventor also discovered that when electrospinning was performed using the HFA solution in which silk-like substance is dissolved, a high quality nonwoven fabric with mutual fusion of fibers could be obtained, and this led to the present invention.

That is, the conditions required of a solvent for silk fibroin are:

(1) it is able to cleave the strong hydrogen bonds in the silk fibroin,

(2) it is able to dissolve the silk fibroins within a short time,

(3) it dissolves silk fibroins without cleaving the molecular chain,

(4) it permits silk fibroins to exist in a stable state for a long time period,

(5) it has a sufficient viscosity for spinning,

(6) it leaves the system easily after silk fibroins solidify (solvent is easily removed).

HFA satisfies all these conditions and is also able to dissolve the silkworm silk fibroin fibers. Moreover, this solution is also suitable for electrospinning.

It is therefore the first object of this invention to provide a nonwoven fabric comprising very fine fibers of silk and/or silk-like material.

It is the second object of this invention to provide a method of manufacturing a high quality nonwoven fabric comprising super fine fibers of silk and/or silk-like material.

### DISCLOSURE OF THE INVENTION

The above objects of the invention are attained by dissolving silk fibroin and/or silk-like material in hexafluoroacetone hydrate or a solvent having this as its main component, and electrospinning the resulting solution.

### BRIEF DESCRIPTION OF THE DRAWINGS

FIG. 1A is an atomic model diagram of hexafluoracetone used as a spinning solvent in this invention. FIG. 1B is an atomic model diagram of a diol which has reacted with a water molecule. FIG. 1C is the reaction equation of the above reaction.

FIG. 2 is a solution-state ¹³C NMR spectrum of B.mori silk fibroin in HFA hydrate.

FIG. 3 is a solid-state ¹³C CP/MAS NMR spectrum of silk fiber regenerated from HFA solution of B.mori silk fibroin.

FIG. 4 is a diagram showing the principle of electrospinning.

FIG. 5 is a SEM image of nonwoven fabric and the histograms of the diameters of silk filament obtained under experimental conditions a, b, c, d of Example 1.

FIG. 6A is a NMR spectrum of B.mori nonwoven fabric after vacuum drying, FIG. 6B is a ¹³C solid-state NMR spectrum of B.mori nonwoven fabric dried under vacuum after immersion in methanol.

FIG. 7A is a SEM image of S.c.ricini nonwoven fabric, FIG. 7B is a histogram of filament diameters calculated from the SEM image.

FIG. 8A is a NMR spectrum of S.c.ricini nonwoven fabric after vacuum drying, FIG. 8B is a ¹³C solid-state NMR spectrum of S.c.ricini nonwoven fabric dried under vacuum after immersion in methanol.

FIG. 9A is a SEM image of B.mori/S.c.ricini mixed nonwoven fabric, FIG. 9B is a histogram of filament diameters calculated from the SEM image.

FIG. 10 is a ¹³C solid-state NMR spectrum of B.mori/S.c.ricini mixed nonwoven fabric dried under vacuum after immersion in methanol.

FIG. 11A is a SEM image of SLP6 nonwoven fabric, FIG. 11B is a histogram of filament diameters calculated from the image.

### THE BEST EMBODIMENT OF THE INVENTION

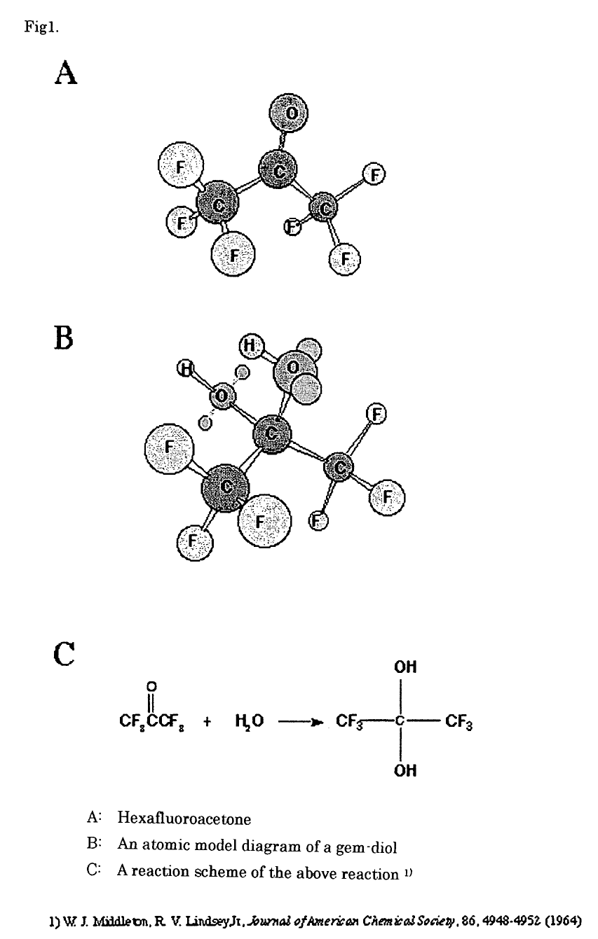

The hexafluoroacetone used according to the preferred form of the invention is a substance shown in A of FIG. 1, and usually exists stably in the form of the hydrate.

Therefore, also in this invention, it is used in the form of the hydrate. There is no particular limitation on the hydration number.

In this invention, it is also possible to dilute HFA with water, HFIP, etc., according to the characteristics of the silk and silk-like material. In this case also, it is preferred that HFA accounts for 80% or more of the total.

In this specification, such a diluted solvent is referred to as a solvent having HFA as its main component.

The silk fibroin used in this invention is silk fibroin of B.mori, and wild silkworms such as S.c.ricini, A.pernyi, A.yamamai.

Moreover, the silk-like material is a synthetic protein represented for example, by the general formula -[(GA¹)ⱼ-((GA²)ₖ-G-Y-(GA³)₁)ₘ]ₙ- or [GGAGSGYGGGYGHGYGSDGG(GAGAGS)₃]ₙ. where, G is glycine, A is alanine, S is serine, Y is tyrosine and H is histidine,

The former synthetic protein is disclosed in the specification W001/70973A1.

A¹ in the general formula may be alanine, and each third A¹ may be a serine.

A² and A³ are also alanine, and part may be replaced by valine.

In this invention, a silk fibroin and/or a silk-like material can be dissolved by HFA alone to give a spinning solution.

It may be mentioned that in the case of HFIP reported previously, B.mori silk fibers and wild silkworm silk fibers could not be dissolved directly.

In the case of HFA, they may firstly be dissolved in LiBr, dialysed to remove LiBr, extruded to manufacture a film, and the resulting film may be dissolved in HFA. The solubility in this case is then better than in the case of HFIP, and not only is operability improved, but the mechanical properties of silk fibers obtained are also better than when HFIP is used as a solvent.

In this invention, a mixture of HFA and HFIP can also be used as a solvent. In this case, the blending ratio of the two solvents may be suitably determined depending on the protein it is desired to dissolve.

In this invention, as the silk fibroin film is dissolved in hexafluoroacetone hydrate, there is effectively no cleavage of the molecular chain, and a silk solution is obtained within a shorter time than in the prior art.

If the dissolution time is further lengthened, not only B.mori silk fibers can be dissolved directly without manufacturing a film, but also the silk fibers of wild silkworms such as the S.c.ricini and A.yamamai can be dissolved directly, and their mixed solutions may be prepared.

If the electrospinning is performed using the obtained solutions, a nonwoven fabric with very fine filaments from tens of nanometer to hundreds of nanometer can be obtained.

The electrospinning method is a method of spinning using high voltage (10-30 kV). In this method, charges are induced and accumulated on the solution surface by the high voltage. These charges mutually repel each other, and this repulsive force opposes the surface tension.

If the electric field force exceeds a critical value, the repulsive force of the charges will exceed the surface tension and a jet of charged solution will be ejected. As the surface area of the ejected jet is large compared to its volume, the solvent evaporates efficiently, and as the charge density is increased due to the decrease of volume, then the jet is split into finer jets.

As described above, due to this process, uniform filaments from tens to hundreds of nanometer are deposited on a meshwork collector (e.g., Fong et al., Polymer 1999, 40, 4585.).

This invention will now be described in further detail by means of specific examples, but it is not to be construed as being limited thereby in any way.

### EXAMPLES

### Example 1

Spring cocoon, 2001, Shunrei×Shogetsu was used as the raw material for B.mori cocoon layer. The sericin protein and other fats covering the fibroin were removed by degumming.

The degumming method is as follows.

Degumming Method

A 0.5 wt % aqueous solution of Marseille soap (Dai-Ichi Kogyo Seiyaku Inc.) was prepared and heated to 100° C. The aforesaid cocoon layer was added into the solution. It was boiled while stirring.

After boiling for 30 minutes, it was rinsed in distilled water heated to 100° C.

This operation was performed 3 times, the cocoon was boiled for 30 minutes again with distilled water, and dried to give the silk fibroin.

As mentioned above, B.mori silk fibroin fibers are soluble in HFA. However, as 2 months or more is required for dissolution, B.mori silk fibroin film was prepared as described below to accelerate dissolution and this was used as the sample.

Preparation of B.mori Silk Nonwoven Fabric

B.mori silk fibroin was dissolved using 9M aqueous LiBr solution, and shaken at 40° C. for 1 hour until the residue dissolved.

The silk fibroin/9M LiBr aqueous solution obtained was filtered under reduced pressure using a glass filter (3G2), packed into a dialysis membrane (Viskase Seles Corp., Seamless Cellulose Tubing, 36/32) after removing dirt in the aqueous solution, and dialysed for 4 days using distilled water to remove LiBr, giving an aqueous solution of B.mori silk fibroin.

This was developed on a plastic plate (No. 2 square Petri dish, Eiken Inc.), and allowed to stand for 2 days at room temperature to evaporate water to give a regenerated B.mori silk fibroin film.

The silk fibroin concentration and dissolution rate were studied using HFA.3H₂O (Fw: 220.07, Aldrich Chem. Co.) as a spinning solvent (Table 1).

The thickness of the film was approx. 0.1 mm.

HFA.3H₂O is volatile, so the dissolution was performed without heating at a constant temperature of 25° C. It was found that in the case of this example, the silk fibroin concentration suitable for spinning mostly was 8-10 wt %.

It was found that the overall dissolution time was very short, i.e., 2 hours at these concentrations.

HFA hydrates exist in various forms. In this example, the trihydrate and x hydrate were used, but no difference in the dissolution ability was observed.

B.mori silk fiber can be dissolved directly in HFA hydrate without manufacturing a film (silk fibroin concentration was 10 wt %), but in this case, the dissolution took 2 months or more.

TABLE 1
Concentration and Dissolution Rate of
B. mori Silk Fibroin
Silk concentration in solution

| (%) | Dissolution time (hours) | State |
|---|---|---|
| 3 | within 0.2 | Δ |
| 5 | within 0.2 | ◯ |
| 8 | 1 | ⊚ |
| 10 | 2 | ⊚ |
| 15 | 2 | ◯ |
| 20 | within 48 | Δ |
| 25 | — | x |

⊚ Best spinning concentration
◯ Good spinning concentration
Δ Unsuitable spinning concentration
x Spinning impossible

The silk fibroin film was introduced in HFA, stirred, and dissolved by allowing to stand at a constant temperature of 25° C. to give a spinning solution.

The spinning stock solution was thin amber color.

Viscosity Measurement of Spinning Stock Solution

The silk fibroin/HFA solution was used for viscosity measurement, of which the silk concentration was adjusted to 10 wt %.

For the measurement, the frequency dependence for a distortion of 50% rad was measured using a mechanical spectrometer (RMS-800, Rheometric Far East Ltd).

The frequency was changed, the viscosity was measured, and the viscosity at 0 shear rate was found by extrapolating this shear rate to 0.

As a result, the viscosity of the spinning stock solution was found to be 18.32 poise.

Measurement of Solution-State ¹³C NMR

In order to perform the structural analysis of B.mori silk fibroin in the spinning stock solution, a solution-state ¹³C NMR measurement was performed.

The measurement was performed at a pulse interval of 3.00 seconds and acquisition number of 12,000 at 20° C., using a JEOL α 500 spectrometer.

The sample was silk fibroin/HFA-xH₂O of which the silk concentration was adjusted to approx. 3 wt %.

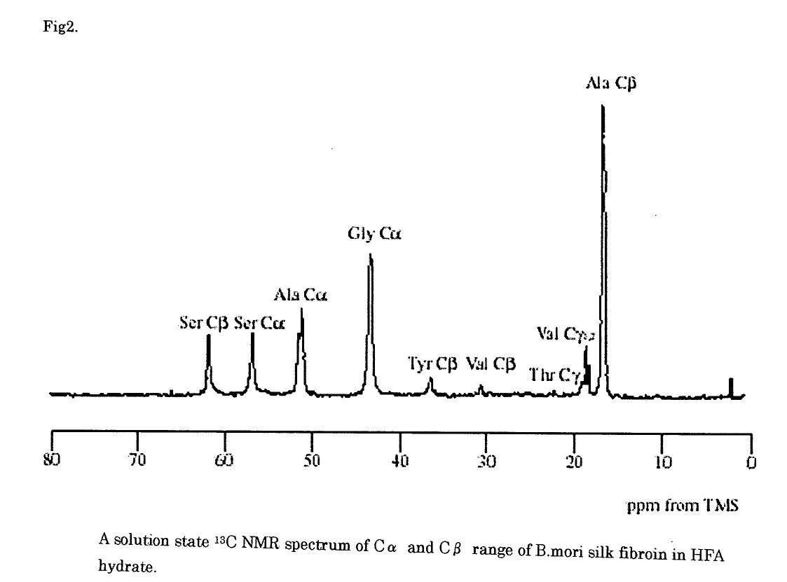

As shown in FIG. 2, it is clear that cleavage of the molecular chain in the silk fibroin does not take place in HFA-xH₂O.

From the chemical shift values of essential amino acids, such as alanine in B.mori silk fibroin, it became clear that the B.mori silk fibroin was an α helix.

Further, from the results of solution-state ¹³C NMR, it was clear that because HFA hydrate existed as a diol (FIG. 1B and C), the silk fibroin therein takes a different dissolution form from that in HFIP which is also a fluorinated alcohol.

On the other hand, from the results of solid-state ¹³C CP/MAS, the structure of the film derived from the spinning stock solution formed an a helix, and a large amount of HFA hydrate remained.

Measurement of Solid-State ¹³C CP/MAS NMR

For measurement of solid-state ¹³C CP/MAS NMR, a Chemagnetic CMX400 spectrometer was used.

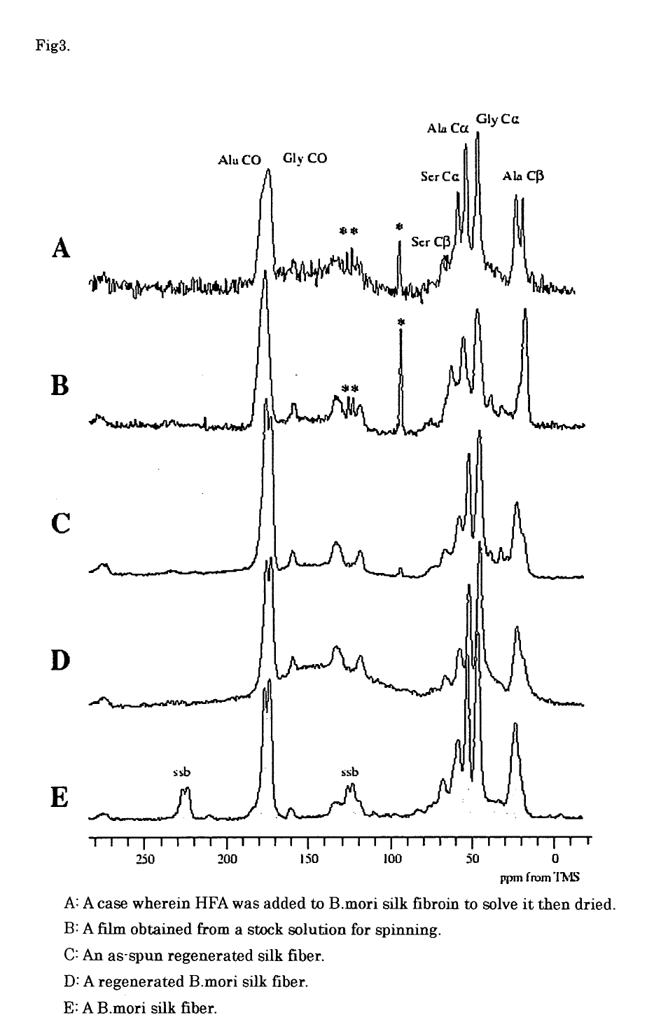

From the spectrum with expanded Cα and Cβ range shown in FIG. 3, it was found that helix conformation in the regenerated film derived from the spinning stock solution was transformed to β sheet structure in the regenerated silk fiber same as that in the natural B.mori silk fibers, and that a structural transition had occurred due to spinning.

In the film prepared from the HFA-xH₂O solution of B.mori silk fibroin, the peaks due to HFA Cα and Cβ were observed. This showed that HFA-xH₂O remained in the B.mori silk fibroin, and could not be removed merely by drying.

Further, although its intensity was small compared also to the as-spun regenerated silk fibers, in which a peak due to HFA-xH₂O was observed.

Five types of B.mori silk fibroins/HFA-xH₂O solutions, i.e., 10, 7, 5, 3, 2 wt %, were produced as described above.

Production of Regenerated B.mori Nonwoven Silk Fibroin Fabrics by Electrospinning

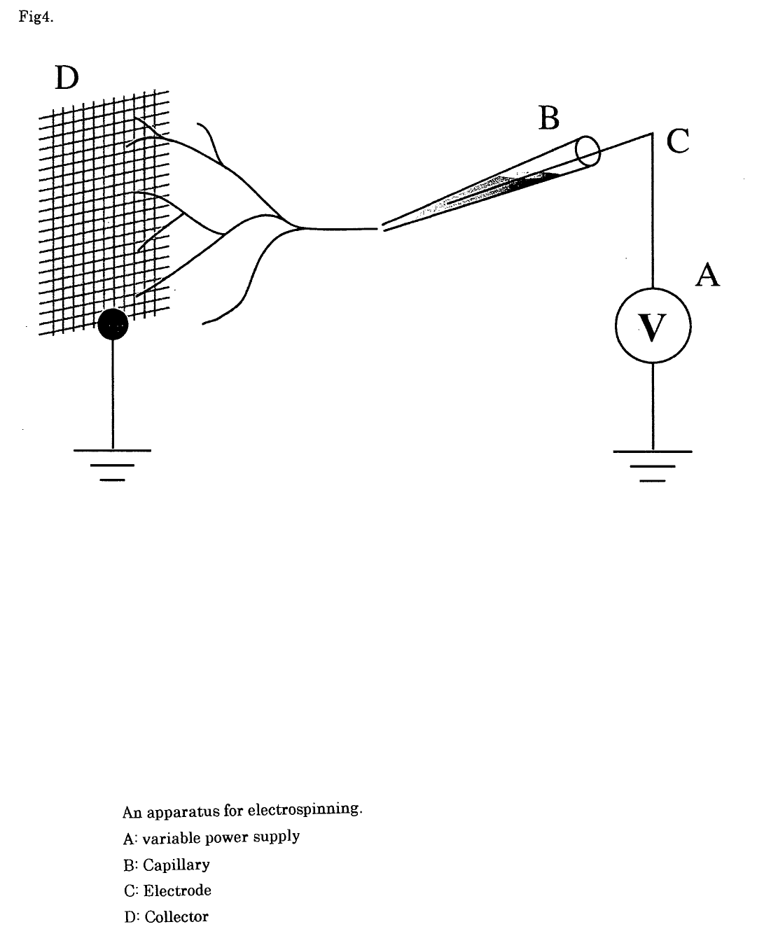

Electrospinning was performed on the above B.mori silk fibroin/HFA.xH₂O solutions using the experimental device shown in FIG. 4.

FIG. 4A is a 0-30 kV variable voltage device (Towa Instruments).

FIG. 4B is a 30 microliter pipetteman tip which functions as a capillary for holding solution (Porex BioProducts Inc.).

The capillary was inclined slightly to the horizontal to extrude spinning solution to the capillary tip under gravity.

FIG. 4C is a copper wire functioning as an electrode for charging the solution. FIG. 4D is a mesh of stainless steel wire (hereafter referred to as a collecting plate) for collecting ejected material, having a width of 10 cm×10 cm, graduated in 1 mm², and a diameter of 0.18 mm.

The distance from the capillary tip to the collection plate is here referred to as the injection distance.

During this experiment, for the 2 wt % solution, the spinning stock solution dripped from the capillary tip, so spinning by the electrospinning method could not be performed.

For the 10 wt % solution, the viscosity was too high, and as the solution was not extruded to the capillary tip, spinning by the electrospinning method could not be performed.

On the other hand, for the 3, 5 and 7 wt % solutions, dripping of the spinning solution from the capillary tip was not observed. Therefore, the spinning conditions by the electrospinning method were studied for the 3, 5 and 7 wt % solutions.

As a result, for the following conditions:

a. concentration 7 wt %, injection distance 15 cm, voltage 20 kV

b. concentration 5 wt %, injection distance 15 cm, voltage 25 kV

c. concentration 5 wt %, injection distance 20 cm, voltage 20 kV

d. concentration 3 wt %, injection distance 15 cm, voltage 15 kV

The white nonwoven fabrics were obtained on the collecting plate.

The nonwoven fabrics with and without immersing in 99% methanol (Wako Pure Reagents Inc.) overnight, respectively, were dried in a vacuum constant temperature drying apparatus SVK-11S (Isuzu Laboratories).

Morphology Observation by Scanning Electron Microscope (SEM)

The morphology of nonwoven fabrics obtained after immersion in methanol and drying was observed, using a scanning electron microscope (hereafter referred to as SEM).

Metal vapor deposition was performed at 30 mA for 60 seconds to give a thickness of approx. 15 nanometers (JEOL, JFC-1200 FINE COATER).

The sample was observed with JEOL, JSM-5200LV SEM.

The accelerating voltage was 10 kV and the working distance was 20.

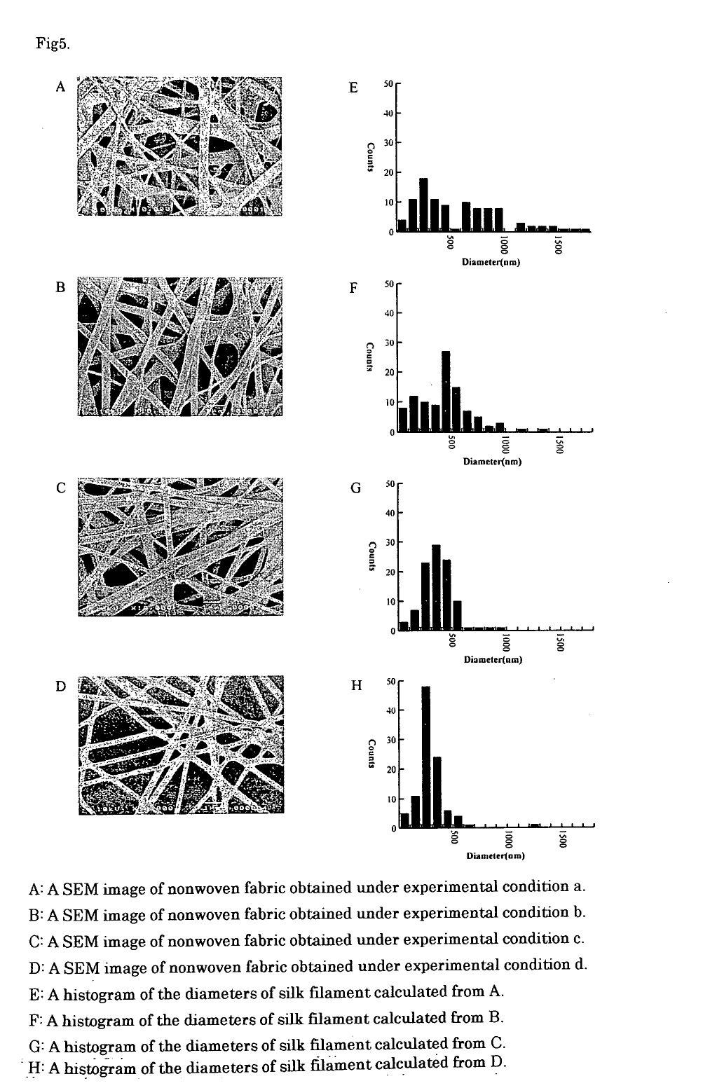

FIGS. 5A, B, C, D are SEM images of nonwoven fabric samples obtained under spinning conditions a, b, c, d, respectively.

From the images, it was confirmed that the nonwoven fabrics were actually the filaments of very fine diameter.

On the SEM images, the filament diameter was measured at the cross sites.

There were 100 measuring points.

FIGS. 5E, F, G, H show the results.

The average diameter also decreases as the concentration of B.mori silk fibroin solution falls.

Further, the width over which the diameter of the fibers is distributed became small as (the concentration of) the B.mori silk fibroin solution decreased, and uniform fibers were obtained.

From FIGS. 5E, F, G, H, it was found that the average diameter in FIG. 5A was 590 nanometers, the average diameter in FIG. 5B was 440 nanometers, the average diameter in FIG. 5C was 370 nanometers and the average diameter in FIG. 5D was 280 nanometers.

¹³C CP/MAS NMR Measurement

The solid-state ¹³C CP/MAS NMR spectrum of the nonwoven fabric sample obtained under the experimental condition d was measured using a Chemagnetic CMX 400 Spectrometer.

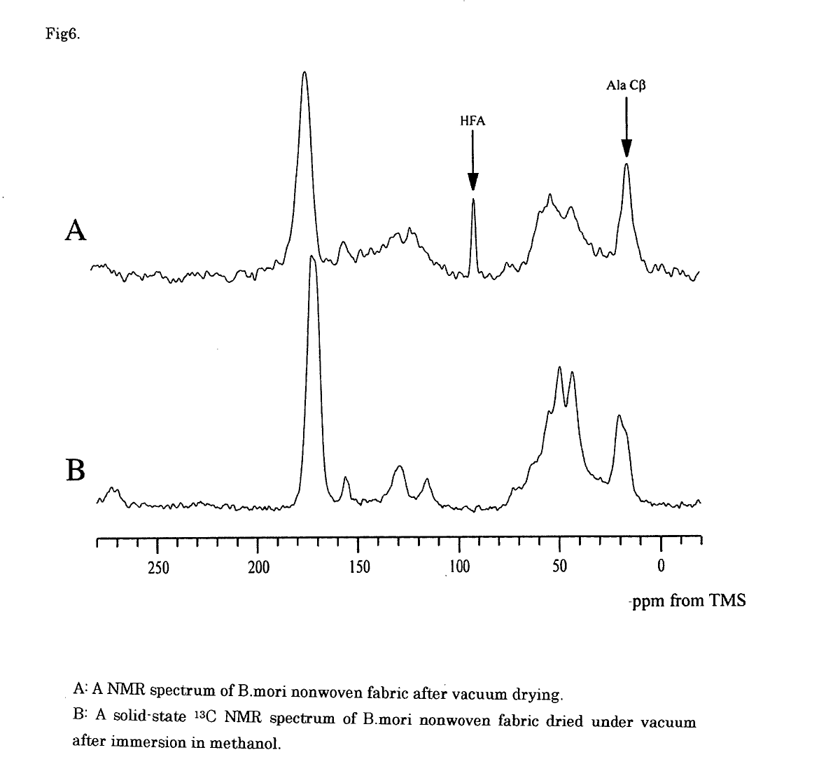

FIG. 6A is the sample after drying under reduced pressure alone, FIG. 6B is the sample after reduced pressure drying, methanol immersion and reduced pressure.

From the spectrum with expanded Cβ range in FIG. 6, it was clear that the sample which had been subjected to reduced pressure drying alone had an essentially helical structure, and in the sample which had been subjected to reduced pressure drying, methanol immersion and reduced pressure drying, the proportion of helix structure decreased and the proportion of β sheet structure increased.

From a comparison of these structures, it was found that the peak due to HFA observed at 90 ppm disappeared, and it was therefore concluded that, due to the reduced pressure drying, methanol immersion and reduced pressure drying, a corresponding amount of HFA had been removed.

### Example 2

The S.c.ricini silk fibroin/HFA-xH₂O solution was produced as follows.

Two concentrations of the solution, i.e., 10 wt % and 7 wt %, were prepared.

Production of S.c.ricini Nonwoven Fabric

S.c.ricini cocoon shells (1998) were used.

This was finely unraveled with pincettes, and the sericin protein and other fat covering the fibroin were removed by degumming to obtain a silk fibroin.

The degumming method is described below.

Degumming Method

An 0.5% wt % aqueous solution of sodium bicarbonate (NaHCO₃) (Wako Pure Reagents, Premier Grade, MW: 84.01) was prepared, and heated to 100° C. The above-mentioned cocoon shells were introduced, and the solution boiled with stirring. After 30 minutes, it was rinsed with distilled water heated to 100° C. This operation was performed 5 times, boiling in distilled water was continued for 30 minutes, and the residue rinsed and dried to give a silk fibroin.

The concentration of the silk fibroin and its dissolution rate in the solvent were measured using HFA-xH₂O as spinning solvent (Tokyo Chemical Industries, Mw: 166.02 (Anh)) (Table 2).

As a result, the concentration of the silk fibroin most suitable for this laboratory system was found to be 10 wt %. The silk fibroin/HFA-xH₂O solution was thin yellow.

HFA.xH₂O has a low boiling point and high volatility, so it was dissolved without heating at a constant temperature of 25° C.

After mixing the silk fibroin with the spinning solution and stirring, it was allowed to stand at a constant temperature of 25° C. to dissolve the silk fibroin, and this was taken as the spinning solution.

TABLE 2
Solution Concentration and Dissolution Rate of
S.c.ricini Silk Fibroin
Silk concentration in solution

| (%) | Dissolution time | State |
|---|---|---|
| 8 | within 2 days | ◯ |
| 10 | 5 | Δ |
| 12 | 10 days or longer | X |

◯ Good spinning concentration
Δ Unsuitable spinning concentration
X Spinning impossible

Production of Regenerated S.c.ricini Silk Fibroin Nonwoven Fabric Samples by Electrospinning

Electrospinning was performed on the above S.c.ricini silk fibroin/HFA.xH₂O solution (FIG. 4).

During this experiment, for the 7 wt % solution, the spinning stock solution dripped from the capillary tip, so spinning by the electrospinning method could not be performed.

For the 10 wt % solution, on the other hand, dripping of the spinning solution from the capillary tip was not observed. When the voltage of the variable voltage device was set to 25 kV and the injection distance was set to 15 cm, stable injection of the solution from the capillary was observed, and a white nonwoven fabric sample could be obtained on the collection board.

This nonwoven fabric sample was dried under reduced pressure without heating overnight in a vacuum constant temperature drying apparatus SVK-11S (Isuzu Laboratories) immersed in 99% methanol (Wako Pure Reagents Inc., Premier Grade) overnight, and reduced pressure drying was then performed without heating overnight in the vacuum constant temperature drying apparatus.

Morphology Observation by Scanning Electron Microscope (SEM)

The morphology of the nonwoven fabric sample obtained after immersion in methanol and drying was observed using a SEM. Metal vapor deposition was performed at 30 mA for 60 seconds to give a thickness of approx. 15 nanometers (JEOL, JFC-1200 FINE COATER).

The sample was observed by SEM (JEOL, JSM-5200 LV SCANNING MICROSCOPE).

The accelerating voltage was 10 kV and the working distance was 20.

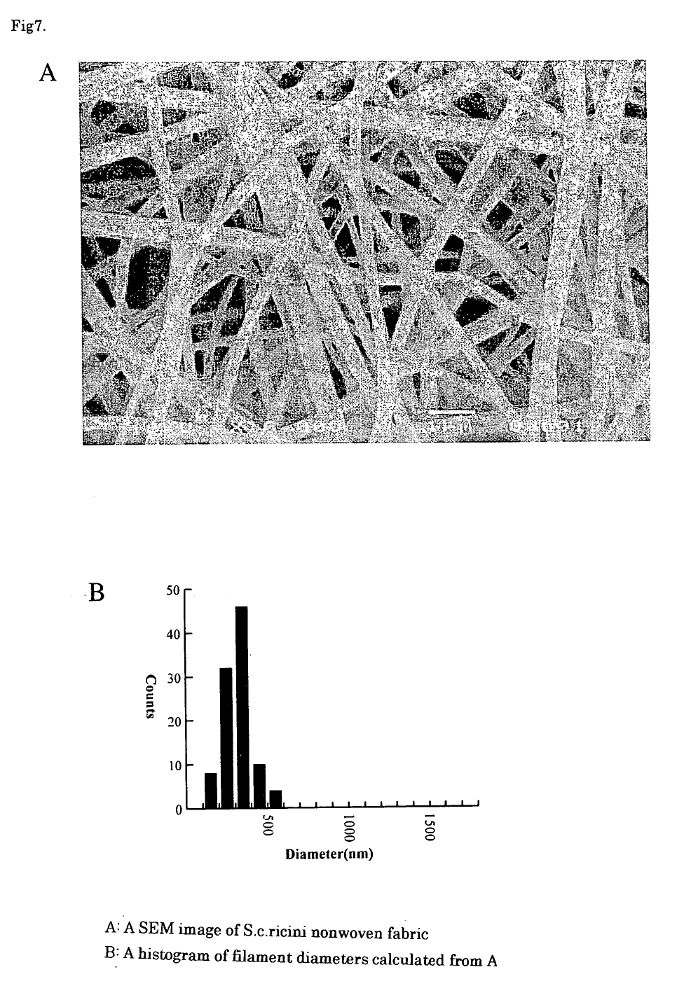

FIG. 7A is the image obtained by SEM.

From this image, it was confirmed that the nonwoven fabric sample was actually a nonwoven fabric of fibers with very fine diameter.

On this SEM image, the fiber diameter was measured where the fibers crossed.

There were 100 measuring points.

FIG. 7B shows the results. It was found that fibers having a diameter of 300-400 nanometers were the most numerous.

¹³C CP/MAS NMR Measurement

Measurement of the solid-state ¹³C CP/MAS NMR spectrum was performed using a Chemagnetic CMX 400 Spectrometer.

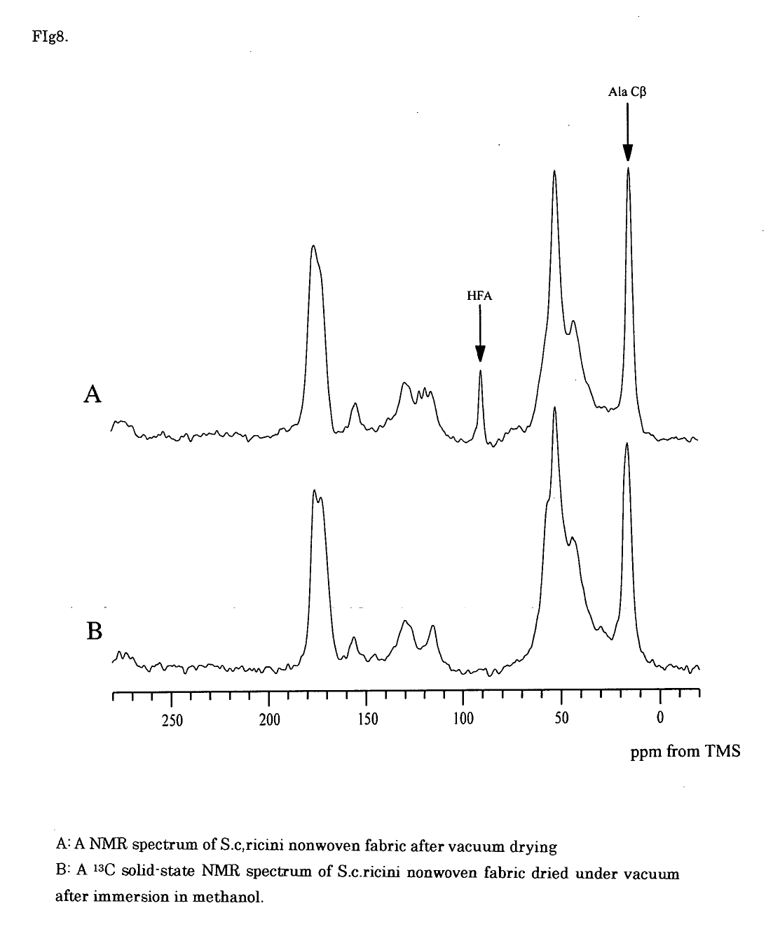

FIG. 8A is the sample after drying under reduced pressure alone, FIG. 8B is the sample after reduced pressure drying, methanol immersion and reduced pressure.

From the spectrum of the Ala Cβ range in FIG. 8, it was clear that the sample which had been subjected to reduced pressure drying alone, and the sample which had been subjected to reduced pressure drying, methanol immersion and reduced pressure drying, both essentially had helix structure.

As the peak due to HFA observed at 90 ppm disappeared, it was concluded that, due to the reduced pressure drying, methanol immersion and reduced pressure drying, a considerable amount of HFA had been removed.

### Example 3

The solutions of 3 wt % B.mori silk fibroin and 10 wt % S.c.ricini silk fibroin/HFA.xH₂O prepared by the methods of Example 1 and Example 2 so that the silk fibroin concentration was equal.

The final concentration of mixed silk fibroin/HFA-xH₂O was 4.62 wt % (concentrations of B.mori silk fibroin and S.c.ricini silk fibroin were respectively 2.31 wt %).

Production of Regenerated B.mori/S.c.ricini Silk Fibroin Mixed Nonwoven Fabric Samples by Electrospinning

Electrospinning was performed on the above B.mori silk/S.c.ricini silk fibroin/HFA.xH₂O using the experimental device shown in Example 1 (FIG. 4).

The conditions under which electrospinning was possible for this mixed solution were examined, by varying the injection distance and voltage. As a result, a nonwoven fabric sample was obtained for an injection distance of 25 cm and voltage of 15 kV.

As a result of performing 5 or more experiments under these conditions, the same nonwoven fabric sample was obtained stably.

This nonwoven fabric sample was immersed in 99% methanol (Wako Pure Reagents Inc., Premier Grade) overnight, and reduced pressure drying was performed without heating in a vacuum constant temperature drying apparatus SVK-11S (Isuzu Laboratories) overnight.

Morphology Observation by Scanning Electron Microscope (SEM)

The morphology of nonwoven fabric sample obtained after immersion in methanol and drying was observed, using a SEM. Metal vapor deposition was performed at 30 mA for 60 seconds to give a thickness of approx. 15 nanometers (JEOL, JFC-1200 FINE COATER).

The sample was observed by SEM (JEOL, JSM-5200 LV SCANNING MICROSCOPE).

The accelerating voltage was 10 kV and the working distance was 20.

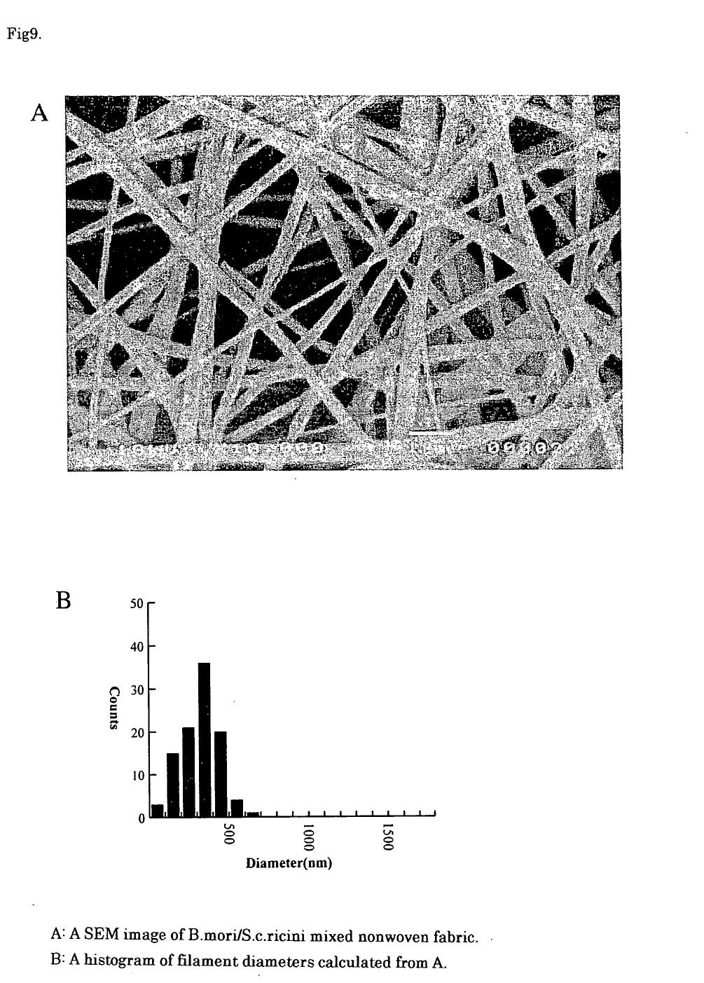

FIG. 9A is the image obtained by SEM.

From this image, it was confirmed that the nonwoven fabric sample was actually a nonwoven fabric of fibers with very fine diameter.

On this SEM image, the fiber diameter was measured where the fibers crossed.

There were 100 measuring points.

FIG. 9B shows the results. It was found that fibers having a diameter of 300-400 nanometers were the most numerous.

¹³C CP/MAS NMR Measurement

Measurement of the solid-state 13C CP/MAS NMR spectrum was performed using a Chemagnetic CMX 400 Spectrometer.

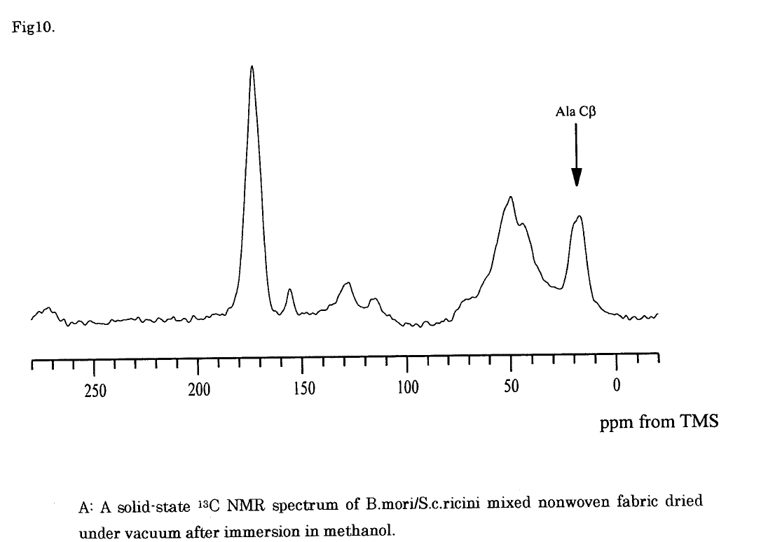

FIG. 10 is the spectrum of a sample after methanol immersion and reduced pressure drying.

From the spectrum of the Ala Cβ range of FIG. 10, it was clear that helix structure and β sheet structure are both formed in the fibers.

Moreover, a peak due to HFA origin was not observed, so it was concluded that a considerable amount of HFA had been removed by methanol immersion and reduced pressure drying.

### Example 4

A SLP6-HFA-xH₂O solution was produced by adding a protein having the sequence TS [GGAGSGYGGGYGHGYGSDGG(GAGAGS)₃AS]₆ and a molecular weight (MW) of approximately 20000 (hereafter, referred to as SPL6) to HFA-xH₂O (Tokyo Chemical Industries), stirring, and allowing to stand in a constant temperature bath at 25° C. to dissolve.

The SLP6-HFA-xH₂O mixed solution adjusted to a concentration of 20 wt % was allowed to stand for one week in a constant temperature bath at 25° C., but the SLP6 did not dissolve completely.

Therefore, HFA-xH₂O was again added to give 12 wt %, and the mixture allowed to stand in the constant temperature bath at 25° C. for another three days.

However, SLP6 did not dissolve completely in this mixed solution, either. Therefore, only the supernatant from this mixed solution was taken as the spinning stock solution.

Conversion of SLP6 to Fibers by the Electrospinning Method

Electrospinning was performed on the above SLP6/HFA.xH₂O solution using the experimental device shown in Example 1 (FIG. 4).

Aluminum foil (Nippon Foil Co.) was used as the collection plate.

As a result by varying distance and voltage and examining the conditions under which electrospinning is possible for the SLP6-HFA solution obtained, a white film formed on the collection plate at an injection distance of 10 cm, and a voltage of 30 kV.

When the experiment was conducted in two steps, a white film was formed twice under the above conditions.

This film sample was immersed in 99% methanol (Wako Pure Reagents, Premier Grade) overnight, and reduced pressure drying was then performed without heating in a vacuum constant temperature drying apparatus SVK-11S (Isuzu Laboratories) overnight.

Morphology Observation by Scanning Electron Microscope (SEM)

The morphlogy of a film sample obtained after immersion in methanol and drying was observed, using a SEM.

Metal vapor deposition was performed at 30 mA for 60 seconds to give a thickness of approx. 15 nanometers (JEOL, JFC-1200 FINE COATER).

The sample was observed by SEM (PHILIPS XL30).

The accelerating voltage was 10 kV and the working distance was 12.9.

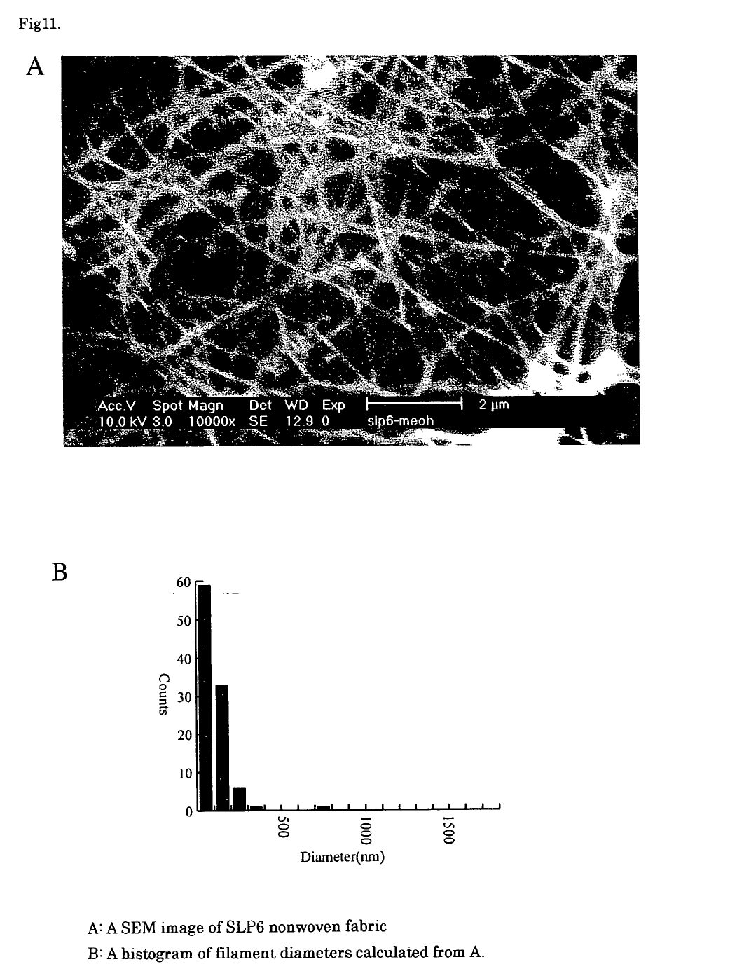

FIG. 11A is the image obtained by SEM.

From this image, it was confirmed that the nonwoven fabric sample was actually a nonwoven fabric of fibers of very fine diameter.

On this SEM image, the fiber diameter was measured where the fibers crossed.

There were 100 measuring points.

FIG. 11B shows the results. It was found that more than half of the fibers for which the diameter was measured, had a diameter of 100 nanometers or less.

Industrial Field of Application

As described in detail above, according to this invention, a high quality nonwoven fabric comprising very fine fibers of silk and/or a silk-material can easily be obtained.

This nonwoven fabric is particularly useful as a medical material, and therefore has very high industrial significance.

What is claimed is:

1. A nonwoven fabric comprising very fine fibers of wild silkworm silk fibroin or very fine fibers of silk-like material, or very fine fibers of at least two types selected from B.mori silk fibroin, wild silkworm silk fibroin and synthetic silk-like material.

2. The nonwoven fabric as defined in claim 1, wherein said very fine fibers are several tens of nanometers-hundreds of nanometers.

3. The nonwoven fabric as defined in claim 1 or 2, wherein said very fine fibers contain at least B.mori silk or wild silkworm silk.

4. A method of manufacturing a nonwoven fabric of several tens of nanometers-several hundred nanometers, wherein at least one material selected from B.mori silk fibroin, wild silkworm silk fibroin and synthetic silk-like material is dissolved in hexafluoroacetone hydrate or a solvent having this as its main component, and then performing electrospinning.

5. The nonwoven fabric as defined in claim 4, wherein the fiber component concentration in the electrospinning solution is 3-10 wt %.
